(19) United States
(12) Patent Application Publication
(10) Pub. No.: US 2012/0008343 A1
(43) Pub. Date: Jan. 12, 2012

(54) High-Voltage Startup Method and Power Management Apparatus

(76) Inventors: Ren-Yi Chen, Hsin-Chu (TW); Wen-Chung Yeh, Hsin-Chu (TW); Tsung-Hsiu Wu, Hsin-Chu (TW); Jian-Heng Guo, Hsin-Chu (TW)

(21) Appl. No.: 13/177,527

(22) Filed: Jul. 6, 2011

(30) Foreign Application Priority Data
Jul. 9, 2010 (TW) 099122705

(51) Int. Cl. H02M 3/335

(52) U.S. Cl. 363/21.09

(57) ABSTRACT

A high-voltage device provides a constant current drained from a high voltage source to charge a filter capacitor, where a voltage level of the higher voltage source is higher than 90 volts. When the operation voltage of the filter capacitor exceeds a first predetermined value, the charging of the filter capacitor by the constant current is stopped. A feedback loop is then used to maintain the operating voltage at substantially a second predetermined value lower than the first one.

### BACKGROUND OF THE INVENTION

1. Field of the Invention

The present invention relates to a high voltage startup method and a power management apparatus thereof.

2. Description of the Prior Art

A power supply is a kind of power management apparatus that transforms power to provide transformed power to an electronic device or component. For example, FIG. 1 illustrates conventional power supply 60, which employs a flyback topology. In FIG. 1, bridge rectifier 62 is utilized for rectifying AC power V_{AC} to provide input power source V_{IN} to transformer 64. When switch 72 is close-circuited, primary winding LP of transformer 64 is charged. When switch 72 is open-circuited, secondary winding LS of transformer 64 discharges to load capacitor 69 via rectifier 66 to generate output power V_{OUT}. Error amplifier EA compares voltage levels of output power V_{OUT} and target voltage V_{TARGET}, and thereby generates compensation signal V_{COM}.

Controller 50 controls signal V_{GATE} according to both compensation signal V_{COM} and current detection signal V_{CS} located at detection terminal CS, and controls switch 72 via gate GATE. Current detection signal V_{CS} corresponds to an inductive current flowing through first winding LP. Power supply specifications of various countries vary, so a voltage level of input power source V_{IN} may be high, and ranges from 90 volts to 264 volts.

At startup, operating voltage source VCC has not established sufficient voltage for controller 50 to turn switch 72 on or off. At this time, input power source V_{IN} charges filter capacitor 65 by providing a current via resistor RST.

Under normal operation, most power of operating voltage source VCC is generated by discharging of secondary winding LA. However, since there is a high voltage difference across the terminals of resistor RST, significant but unnecessary power consumption is introduced at input power source V_{IN}.

### BRIEF DESCRIPTION OF THE DRAWINGS

FIG. 1 illustrates conventional power supply acquiring a flyback topology.

FIG. 2 illustrates power supply disclosed in the present invention.

FIG. 3 illustrates part of the circuit structure of controller.

FIG. 4 is a signal timing diagram related to the embodiment shown in FIG. 3.

FIG. 5 illustrates controller according to another embodiment from controller shown in FIG. 2.

FIG. 6 illustrates a signal timing diagram based on the embodiment shown in FIG. 5.

FIG. 7 illustrates controller according to another embodiment of controller shown in FIG. 2

FIG. 8 illustrates signal timings for the embodiment shown in FIG. 7.

### DETAILED DESCRIPTION

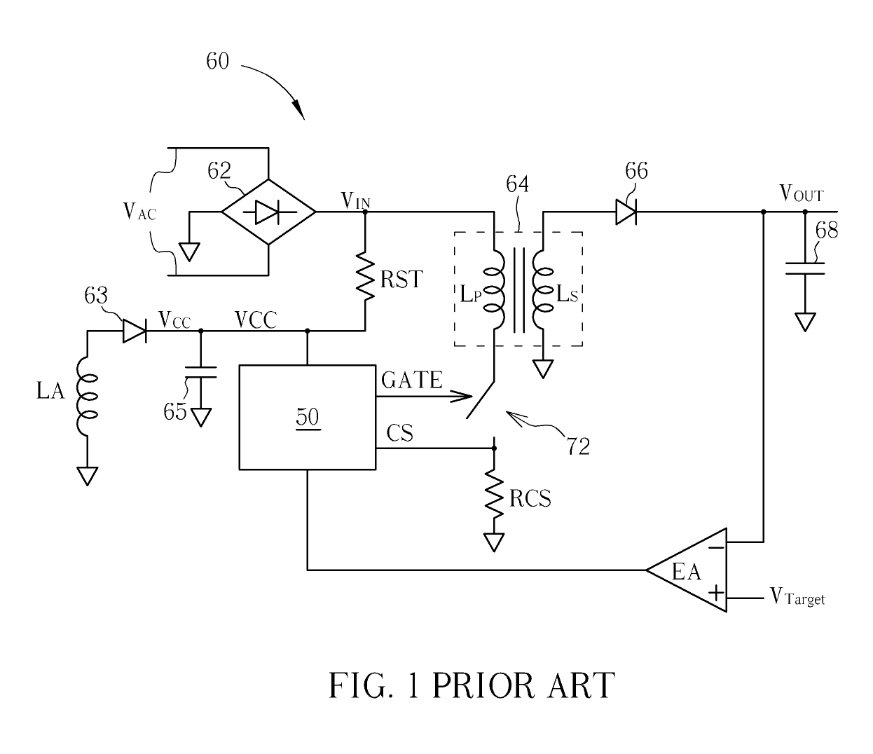

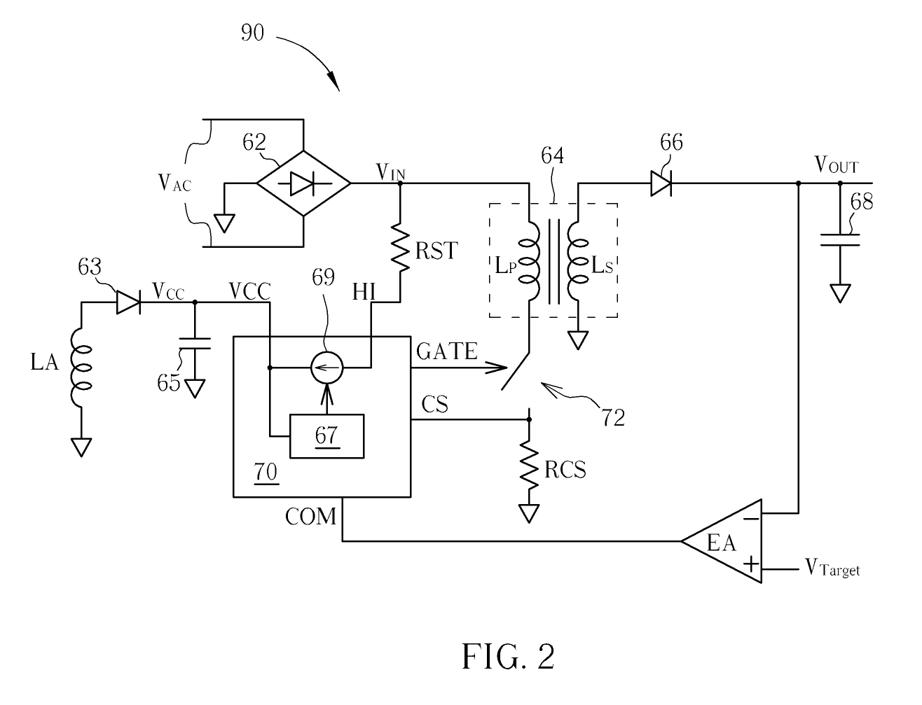

FIG. 2 illustrates power supply 90 disclosed in the present invention. Similar reference numerals used in FIG. 1 and FIG. 2 indicate same elements, same devices, or same signals, and are not described repeatedly for brevity. Embodiments generated by using elements the same as or similar to elements shown in FIG. 1 should also be regarded as embodiments of the present invention. Scope of the present invention should also follow claims of the present invention.

In one embodiment of the present invention, controller 70 shown in FIG. 2 may be a single-chip integrated circuit. In another embodiment of the present invention, controller 70 may be integrated with both switch 72 and resistor RCS to be a single-chip integrated circuit.

Controller 70 has high-voltage activation terminal HI connected to input power source V_{IN} via resistor RST. Controllable current source 69 is coupled between operating voltage terminal VCC and high-voltage activation terminal HI. Detection unit 67, coupled between operating voltage terminal VCC and a control terminal of current source 69, is used for detecting voltage level of operating voltage terminal VCC, i.e. voltage of filter capacitor 65, to control current source 69.

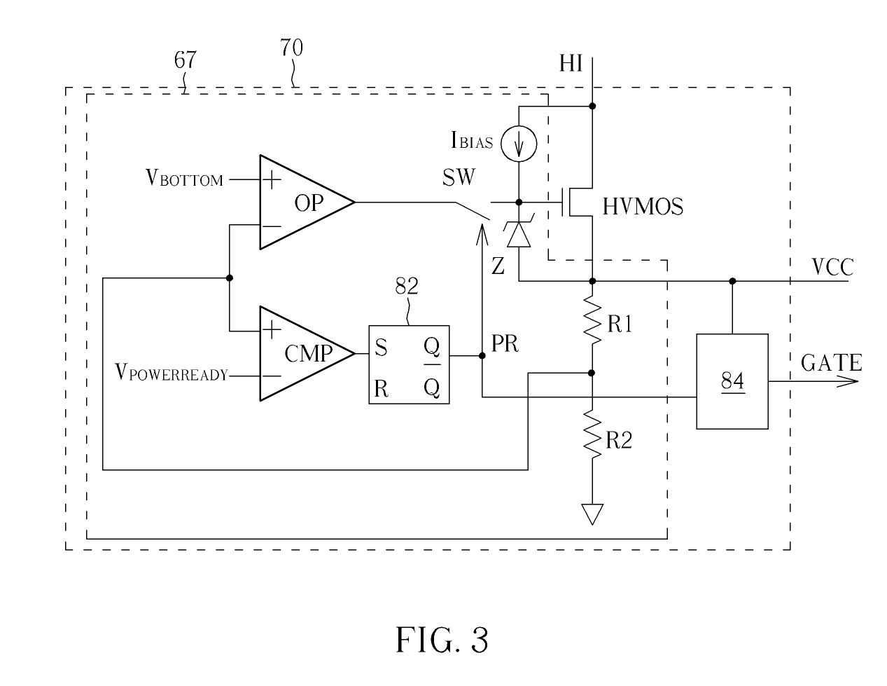

FIG. 3 illustrates part of the circuit structure of controller 70. Current source 69 may be implemented by high-voltage N-type metal-oxide semiconductor (MOS) transistor HVMOS. For example, transistor HVMOS maybe a double diffusion metal-oxide semiconductor (DMOS) transistor. Terminals of transistor HVMOS are respectively connected to high-voltage activation terminal HI and operating voltage terminal VCC. Gate of transistor HVMOS is controlled by detection unit 67.

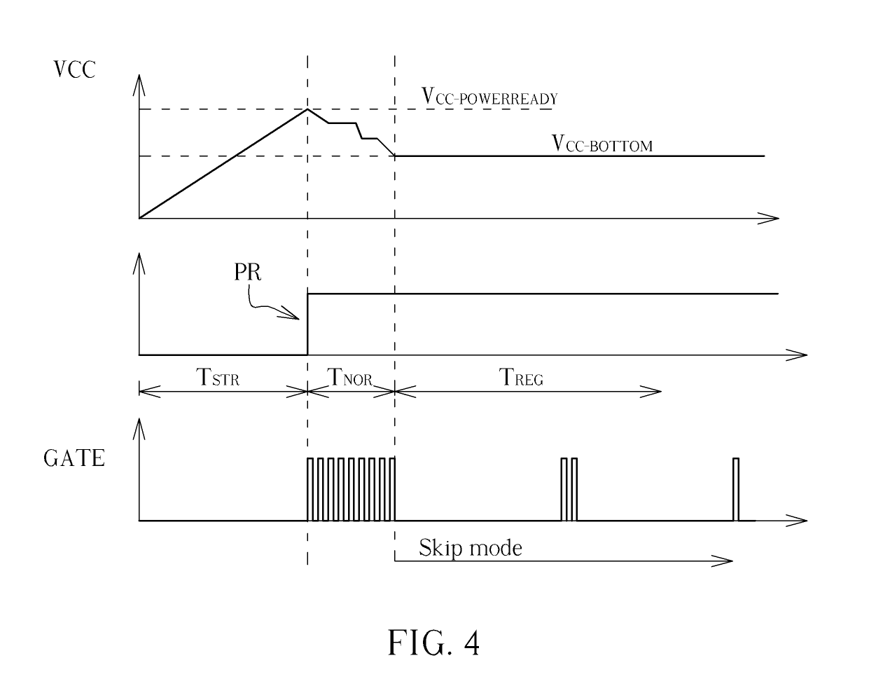

Please refer to FIG. 3 and FIG. 4 simultaneously. FIG. 4 is a signal timing diagram related to the embodiment shown in FIG. 3. FIG. 4 illustrates voltage levels of the operating voltage terminal VCC, output terminal PR of S-R flip-flop 82, and gate GATE.

In the moment of startup, voltage level at output terminal PR of S-R flip-flop 82 indicates logical 0, so the switch SW is open-circuited. Constant gate voltage V_{GS} is provided to transistor HVMOS due to constant current source I_{BIAS} and zener diode Z. Constant current source I_{BIAS} may be implemented by field effect transistor (FET). At this time, transistor HVMOS is operated in the saturation region to provide a constant current for charging filter capacitor 65 via operating voltage terminal VCC. It can be seen that in period of time T_{STR} shown in FIG. 4, voltage level of filter capacitor 65, i.e. the voltage level of operating voltage terminal VCC, is raised in a linear correspondence with time. During the period of time T_{STR} shown in FIG. 4, switch controller 84 keeps switch 72 turned off, and the voltage level at gate GATE is kept low.

After a voltage level at an intermediate node of voltage-dividing resistors R1 and R2 reaches predetermined ready voltage V_{POWERREADY}, comparator CMP transits the voltage level at output terminal PR of S-R flip-flop 82, and latches said voltage level at logical 1, as can be observed at the start of period of time T_{NOR}. Switch SW is kept conducting, and switch controller 84 begins turning switch 72 on periodically for controlling a current flowing through primary winding LP, as indicated by period of time T_{NOR} shown in FIG. 4.

After the voltage level of operating voltage terminal VCC exceeds voltage V_{CC-POWERREADY} which corresponds to predetermined ready voltage V_{POWERREADY}, voltage-dividing resistors R1, R2, operational amplifier OP, and transistor HVMOS form a feedback loop due to conducted switch SW. When voltage level of an intermediate node of voltage-dividing resistors R1, R2 is higher than predetermined lower bound voltage V_{BOTTOM}, operational amplifier OP keeps transistor HVMOS switched off, so that power consumption of transistor HVMOS can be roughly ignored. At this time, the voltage level at operating voltage terminal VCC may rise or fall, as can be observed in period of time T_{NOR} shown in FIG. 4. For example, if power consumption introduced at operating voltage terminal VCC by both switch controller 84 and detection unit 67 is higher than power provided by secondary winding LA, the voltage level of operating voltage terminal VCC is reduced. Else, the voltage level of operating voltage terminal VCC is raised. During period of time T_{NOR} shown in FIG. 4, the voltage level of operating voltage terminal VCC is roughly kept above voltage V_{CC-BOTTOM} which corresponds to lower bound voltage V_{BOTTOM}. As shown in FIG. 4, voltage V_{CC-POWERREADY} is higher than voltage V_{CC-BOTTOM}.

Power supplied by secondary winding LA is related to power stored in primary winding LP. For example, when determining that without switching the whole clock cycles of switch 72 can still get the sustaining voltage level at output voltage source V_{OUT} according to compensation signal V_{COM} at compensation terminal COM, switch controller 84 will operate in a skip mode. The skip mode indicates skipping, or ignoring, at least one clock cycle between two turn-on events of switch 72, i.e. switch 72 is not switched between the two turn-on events, as can be observed in the voltage level at gate GATE during period of time T_{REG} shown in FIG. 4. In the skip mode, since power stored in primary winding LP is insufficient each time switch 72 tuned on, power provided by secondary winding LA is insufficient accordingly, and thus the voltage level of operating voltage terminal VCC drops continuously. The feedback loop including voltage-dividing resistors R1, R2, operational amplifier OP, and transistor HVMOS drains current from input voltage source V_{IN}, whose voltage level is higher than 90 volts, via high-voltage startup terminal HI under the skip mode so as to charge filter capacitor 65, making the voltage level at the intermediate node of voltage-dividing resistors R1, R2 roughly equal to lower bound voltage V_{BOTTOM}, as can be observed in period of time T_{REG} shown in FIG. 4. At this time, switch controller 84 is held enabled to turn switch 72 on, and to control the current flowing through primary winding LP.

Embodiments shown in FIG. 2, FIG. 3, and FIG. 4 include the following advantages:
1. When the voltage level of operating voltage terminal VCC is between voltages V_{CC-POWERREADY} and V_{CC-BOTTOM}, input voltage source V_{IN} will not charge filter capacitor 65, so power consumption caused by the voltage drop between input voltage source V_{IN} and operating voltage terminal VCC is prevented.
2. When secondary winding LA provides insufficient power, like in skip mode, input voltage source V_{IN} charges filter capacitor 65 to sustain the voltage level of operating voltage terminal VCC at roughly voltage V_{CC-BOTTOM}. Therefore, the voltage level of operating voltage terminal VCC is prevented from going too low to control switch 72 by switch controller 84.

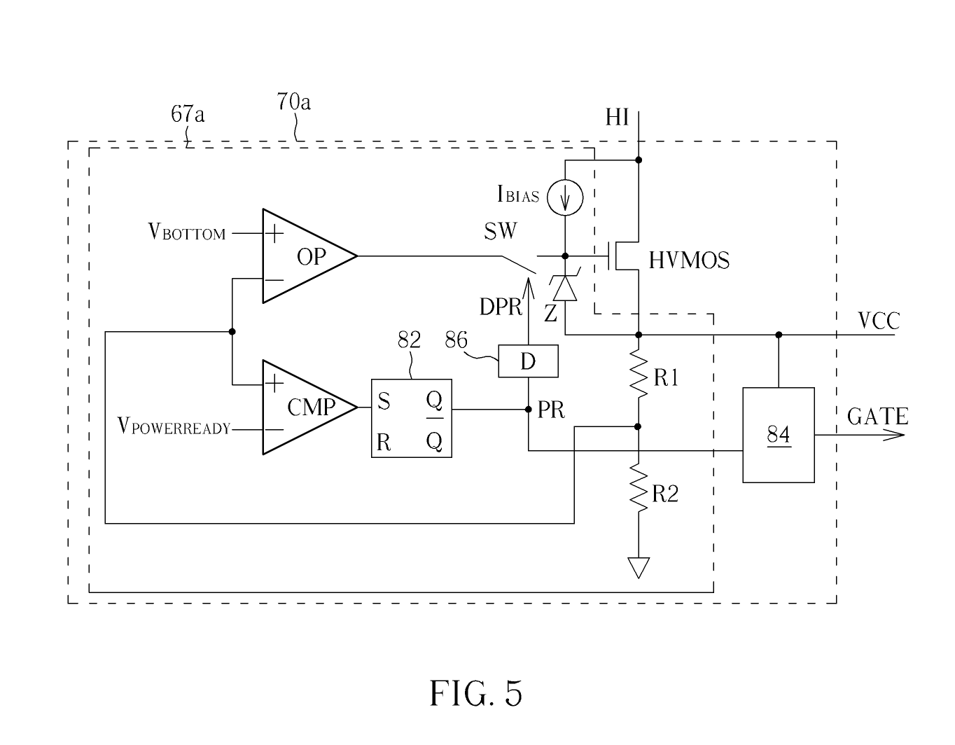

FIG. 5 illustrates controller 70a according to another embodiment different from controller 70 shown in FIG. 2. Same or similar components shown in FIG. 3 and FIG. 5 are not repeatedly described for brevity. A difference between the embodiments shown in FIG. 3 and FIG. 5 lies in delay device D of detection unit 67a shown in FIG. 5, where delay device D is coupled between the control terminal of switch SW and output terminal PR of S-R flip-flop 82. Delay device D further has output terminal DPR.

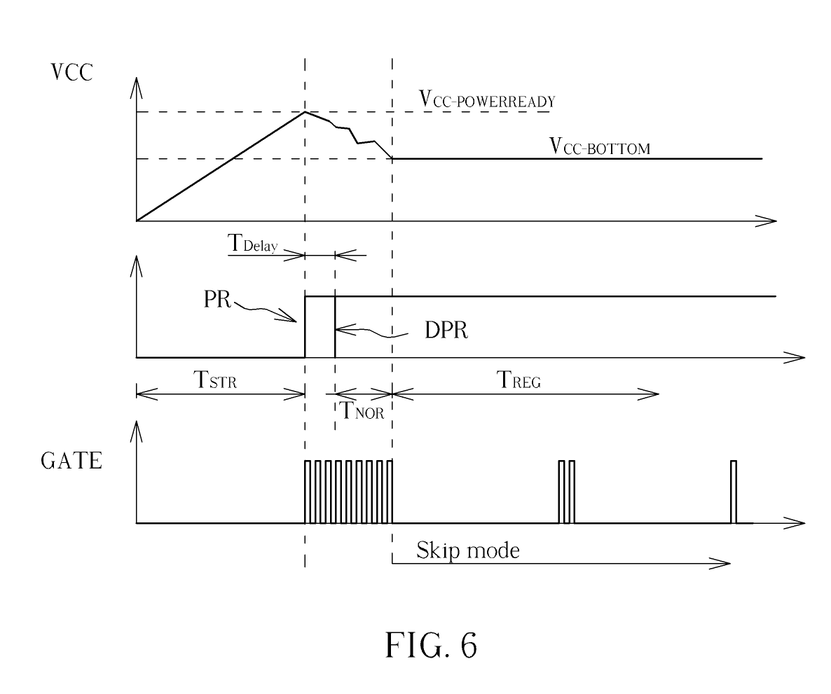

FIG. 6 illustrates a signal timing diagram based on the embodiment shown in FIG. 5. FIG. 6 illustrates voltage levels at operating voltage terminal VCC, output terminals PR and DPR, and gate GATE. As shown in FIG. 6, when the voltage level at output terminal PR is transitioned from logical 0 to logical 1, the voltage level at terminal DPR is also transitioned from logical 0 to logical 1 with delay period of time T_{DELAY} introduced by delay device D, for providing a delayed transition to the above-mentioned feedback loop. In other words, after switch controller 84 is enabled due to the voltage level at operating voltage terminal VCC reaching V_{CC-POWERREADY}, the constant current provided by transistor HVMOS is not turned off right away. Instead, the constant current is sustained by delay period of time T_{DELAY} for charging filter capacitor 65, where delay period of time T_{DELAY} may indicate a soft start of controller 70a. Normally, after enabled for a period, switch controller 84 has a mechanism to control switch 72 or the current flowing through primary winding LP independent of the status of the current or voltage level of output voltage source V_{OUT}. Such a period is known as a “soft start time” by those skilled in the related art. For example, during the soft start time, a peak current flowing through primary winding LP is increased linearly, or a clock cycle of controller 70a is gradually shortened, i.e. the corresponding frequency is gradually raised, and both the peak current and the clock cycle are independent of the voltage level of output voltage source V_{OUT}, which may be too low at startup.

During the soft start time, power stored in primary winding LP is mostly consumed in establishing output voltage source V_{OUT}, so that the power cannot be further utilized for charging filter capacitor 65. Therefore, in the embodiment shown in FIG. 5, during the soft start time, the constant current is drained continually from input voltage source V_{IN} for charging filter capacitor 65 to prevent the voltage level at the operating voltage terminal VCC from dropping rapidly. In other words, filter capacitor 65 may be selected at a lower capacitance to save system cost.

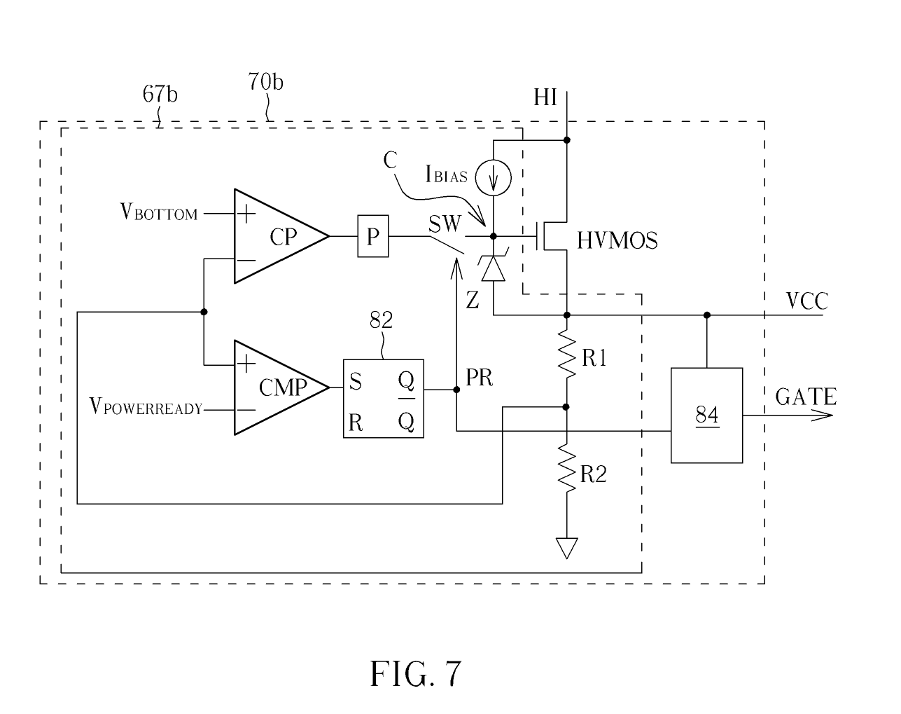

FIG. 7 illustrates controller 70b according to another embodiment of controller 70 shown in FIG. 2. Same or similar components and functions of embodiments shown in FIG. 3 and FIG. 7 are not repeatedly described for brevity. The difference between the embodiments shown in FIG. 3 and FIG. 7 lies in comparator CP shown in FIG. 7, where comparator CP is utilized for determining whether the voltage level at the intermediate node of voltage-dividing resistors R1, R2 is lower than predetermined lower bound voltage V_{BOTTOM}. If the voltage level at the intermediate node of voltage-dividing resistors R1, R2 is higher than predetermined lower bound voltage V_{BOTTOM}, transistor HVMOS is kept turned off, so that no current is provided by transistor HVMOS. When comparator CP indicates that the voltage level at the intermediate node of voltage-dividing resistors R1, R2 is lower than predetermined lower bound voltage V_{BOTTOM}, pulse generator P issues a pulse having constant period of time T_{PUL} for causing transistor HVMOS to provide a constant current for constant period of time T_{PUL} to charge filter capacitor 65.

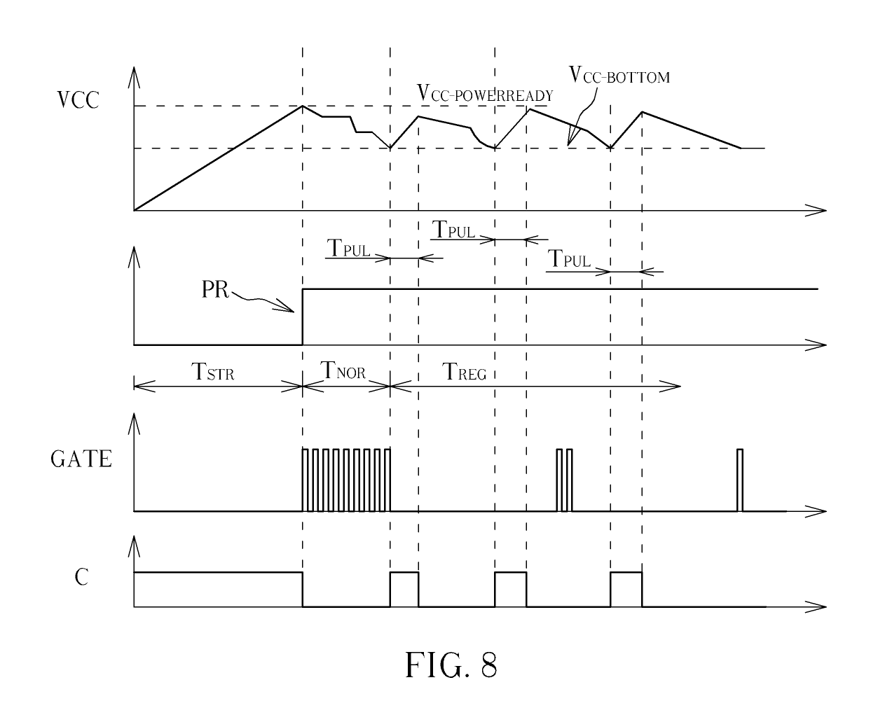

FIG. 8 illustrates signal timings for the embodiment shown in FIG. 7. FIG. 8 illustrates voltage levels at operating voltage terminal VCC, output terminal PR, gate GATE, and control terminal C of transistor HVMOS. As shown in FIG. 8, when the voltage level at operating voltage terminal VCC drops to voltage V_{CC-BOTTOM}, comparator CP transitions to cause control terminal C of transistor HVMOS to receive the pulse generated by pulse generator P and lasting for constant period of time T_{PUL}. Therefore, transistor HVMOS starts providing the current to charge filter capacitor 65 to cause the voltage level at operating voltage terminal VCC to rise. After exceeding constant period of time T_{PUL}, transistor HVMOS is turned off, and the voltage level at operating voltage source VCC also drops in correspondence with power consumption of controller 70b.

Embodiments shown in FIG. 7 and FIG. 8 may provide higher transition performance under the skip mode. In FIG. 7, transistor HVMOS is operated in a turned-off state, or utilized for providing a constant current. In comparison to transistor HVMOS shown in FIG. 3, and mostly operated under different statuses of the saturation region, transistor HVMOS shown in FIG. 7 consumes less power, so that controller 70b shown in FIG. 7 saves more power.

The embodiments of the present invention may be utilized in a switched-mode power supply (SMPS) having a flyback topology, or in an SMPS based on a down-converter or an up-converter.

Those skilled in the art will readily observe that numerous modifications and alterations of the device and method may be made while retaining the teachings of the invention.

What is claimed is:

1. A high-voltage (HV) startup method for a power supply, the high-voltage startup method comprising:
providing a constant current drained from a high voltage source to charge a filter capacitor by a high voltage element, wherein the voltage level of the high voltage source is higher than 90 volts;
stopping charging the filter capacitor after an operating voltage of the filter capacitor exceeds a first predetermined voltage; and
providing a feedback loop to make the operating voltage approximately equal to a second predetermine voltage lower than the first predetermined voltage.

2. The high-voltage startup method of claim 1, comprising
providing the constant current to charge the filter capacitor within a predetermined delay period of time when the operating voltage exceeds the first predetermined voltage; and
stopping charging the filter capacitor with the constant current after the predetermined delay period of time.

3. The high-voltage startup method of claim 1 further comprising:
starting switching a switch for controlling a current flowing through an inductive element when the operating voltage exceeds the first predetermined voltage.

4. The high-voltage startup method of claim 3 further comprising:
continuing to switch the switch for controlling the current flowing through the inductive element when the operating voltage equals the second predetermined voltage.

5. The high-voltage startup method of claim 1, further comprising:
charging the filter capacitor by a secondary winding when the operating voltage exceeds the first predetermined voltage.

6. The high-voltage startup method of claim 1 wherein the feedback loop causes the operating voltage to be approximately the second predetermined voltage when the power supply is operated in a skip mode.

7. A power management apparatus comprising:
a high voltage element, coupled to a high voltage source and a filter capacitor, having a control terminal, and a voltage level of the high voltage source higher than 90 volts; and
a detection unit, coupled to the filter capacitor and the control terminal, for detecting a voltage of the filter capacitor to control the high voltage element;
wherein the high voltage element provides a constant current for charging the filter capacitor within a startup period of time; and
wherein the detection unit and the high voltage element provide a feedback loop for causing the operating voltage to be approximately a second predetermined voltage lower than a first predetermined voltage when the voltage of the filter capacitor exceeds the first predetermined voltage.

8. The power management apparatus of claim 7, wherein the feedback loop causes the operating voltage to be approximately the second predetermined voltage when the power supply is operated in a skip mode.

9. The power management apparatus of claim 7 further comprising:
a switch controller, coupled to a switch and the detection unit, supplied with power by the filter capacitor;
wherein when the operating voltage exceeds the first predetermined voltage, the switch controller begins switching the switch for controlling a current flowing through an inductive element.

10. The power management apparatus of claim 9 wherein the switch controller continues switching the switch for controlling the current flowing through the inductive element when the operating voltage is approximately equal to the second predetermined voltage.

11. The power management apparatus of claim 7, wherein the high voltage element is an double diffusion Metal Oxide Semiconductor (DMOS) having a control terminal coupled to the high voltage source with a constant current source.

12. The power management apparatus of claim 7 further comprising:
a delay device for providing a delay period of time;
wherein the feedback loop is only provided when the voltage of the filter capacitor has exceeded the first predetermined voltage for a period of time longer than the delay period of time.

13. The power management apparatus of claim 12, wherein the delay period of time is a soft start time of the power management apparatus.

14. A high-voltage startup method for a power supply, the high-voltage startup method comprising:
providing a first constant current drained from a high voltage source to charge a filter capacitor by a high voltage element, wherein the voltage level of the high voltage source is higher than 90 volts;
stopping charging the filter capacitor with the first constant current after an operating voltage of the filter capacitor exceeds a first predetermined voltage; and
providing a second constant current to charge the filter capacitor by the high voltage element within a predetermined period of time after the operating voltage of the filter capacitor drops below a second predetermined voltage.

15. The high-voltage startup method of claim 14 wherein providing the second constant current to charge the filter capacitor by the high voltage element within the predetermined period of time comprises:
generating a pulse having the predetermined delay period of time to cause the high voltage element to provide the second constant current for charging the filter capacitor after the operating voltage of the filter capacitor drops below the second predetermined voltage.
